(19) United States
(12) Patent Application Publication
(10) Pub. No.: US 2014/0019561 A1
(43) Pub. Date: Jan. 16, 2014

(54) Systems and Methods for Interactive Content Generation

(71) Applicants: Naftali Anidjar Belity, New York, NY (US); Leon Mirmanas, Toronto (CA)

(72) Inventors: Naftali Anidjar Belity, New York, NY (US); Leon Mirmanas, Toronto (CA)

(21) Appl. No.: 13/713,464

(22) Filed: Dec. 13, 2012

Related U.S. Application Data
(60) Provisional application No. 61/670,056, filed on Jul. 10, 2012.

(51) Int. Cl. H04L 12/58

(52) U.S. Cl. CPC H04L 51/22
USPC 709/206

(57) ABSTRACT

The present invention is a computer network implemented communication platform that enables senders to send to recipients electronic communications based on one or more selected locations, each location being associated with at least one recipient. The present invention includes validating the senders so as to establish trust with recipients. The platform of the invention provides a map based utility enabling a sender to define the scope of location based communication. The platform also incorporates a change of address procedure that enables the updating of location based records. The system and method provide significant advantages over postal mail and traditional email systems.

This application claims the benefit of U.S. Provisional Patent Application Ser. No. 61/670,056 filed Dec. 13, 2011.

### FIELD OF THE INVENTION

The present invention relates generally to computer systems and more specifically to methods and systems for location based communication between a sender and one or more recipients.

### BACKGROUND OF THE INVENTION

Despite the convenience of electronic communications (including email, text messaging, instant messaging, mobile data messaging and other forms of electronic communications—referred to generally in this disclosure as “email”), traditional postal mail still provides advantages. Traditional postal mail (‘postal mail’) enables paper communications to be sent to recipients based on their location alone. The location information is easy to obtain, and the particulars of the occupant of a location are not required. While the occupants of a location will vary, postal addresses generally tend to remain the same. For example individuals who are interested in sending a communication to their neighbours (but do not know all of their names) or to those on their street, postal mail provides a good solution. Similarly, businesses or government entities who are interested in sending communications based on location, for example a business is running a local promotion in a particular neighbourhood, postal mail provides significant advantages in terms of ease of use and convenience.

In contrast, email communications require knowledge of the individual's email address. Obtaining this information, and especially relating this to a particular location can be challenging if not impossible. Furthermore, individuals may maintain multiple email addresses, and also their email addresses may change. Also, when individuals or businesses move they tend to maintain their email address. Therefore in the numerous situations where an individual, business, or government entity wishes to communicate with one or more others based on location, there may be challenges in email meeting the objectives for communication particularly location based communication.

Particularly in connection with communications between senders and recipients unknown to the senders, email communications have significant disadvantages in comparison to postal mail. Accordingly, there continues to be a gap between what email can deliver and what in certain circumstances postal mail can provide to senders/recipients.

However, postal mail can be costly, because of delivery costs and also costs associated with the printing of documents in paper form. In addition, and perhaps most importantly, the production and disposal of print materials, especially coloured materials such as brochures or flyers, has significant environmental disadvantages.

There are also deficiencies in prior art solutions when one considers the importance of marketing campaigns to various entities.

Various entities send a range of different communications to customers and potential customers. These entities include businesses and government entities. Some of these communications are between senders and recipients where there is a pre-existing business relationship, e.g. communications between a bank and its customers. But even in the context of such a pre-existing business relationship, a business for example has an interest in sending to its customers various marketing material for example regarding other services, or with a view to increasing business with the customer, generating brand loyalty, etc. Associated material, even from a business known to the recipient may not be wanted by most if not all customers receiving it. Nonetheless, many businesses spend significant amounts of money creating, printing and delivering communications to customers, in the hope that positive benefits arise at least in the case of a subset of recipients of the materials.

Other businesses are trying to establish new business relationships, and sending material regarding their business or offerings on an unsolicited basis.

Tremendous resources are devoted by businesses and government entities alike to connect with consumers in this way. Traditional postal delivery of papers to home and business addresses is still very popular, because while electronic communications such as email are less expensive, and more friendly to the environment, many recipients filter spam and therefore communications are not received, and furthermore traditional postal delivery enables businesses and government entities to target communications based on location in ways that may serve business, government, and consumer interests better, thus providing better return on the investment in the communications.

However, the continuing mass of paper communications is an enormous environmental problem, contributing to landfill, expending significant carbon resources in creating and delivering the materials physically, and producing materials (for example glossy paper materials) that may result in release of toxins to the environment.

It should be understood that some prior art solutions improve safety using encryption solutions to block unauthorized messages. These solutions can be relatively costly, and registration requirements can be cumbersome and furthermore these solutions often require modification of behaviour in using traditional communication mechanisms which translates into relatively low user adoption.

Spam filters are often used as well and these present problems. Spam filters sometimes unintentionally block important messages from senders that recipients wish to receive. Conversely, in order to avoid this problem, encryption solutions sometimes define filter settings with lower thresholds, which in turn may increase spam to unacceptable levels. Also, numerous entitles use a number of different mechanisms to “fool” spam filters.

Generally speaking, business and government entities are motivated to ensure flexible communication with recipients, regardless of whether consumers want to receive these communications. Generally speaking consumers wish to limit unsolicited communications, even though in some cases they need to receive these communications, or once received they appreciate these communications. Businesses and government entitles must expend fairly significant resources in working around this reluctance to receive unsolicited communications, for example by operating calling centres to solicit acceptance of mail from consumers, web advertising campaigns, mass traditional postal mailings and so on.

In addition, one deficiency of postal mail is that there is no mechanism (at least with ordinary mail as opposed to a registered letter or courier, which is more expensive) to verify that a postal mail recipient has actually received a particular piece of mail. With email, even if the email address for a recipient is known, the identity of the recipient is not normally validated, in part because anybody can register a standard email address and associate with that email address a name, whether it is their name or not. This presents challenges in sending mail to a person where it is necessary to validate that they received the mail in question. For example, when a parking ticket or court summons is issued, it is far too easy using prior art solutions for the recipient to be able to say that they did not pay the fine or did not appear in Court because they did not receive the communication, and there is no way to demonstrate the contrary, and providing a validated means of delivery may be too costly. There is a need for an improved system and method of delivery of communications based on location that addresses this requirement as well.

Essentially, the divergence of interests between consumers and business and government entities results in an escalation of costs and significant negative environmental impact.

Therefore there is a need for an electronic communication system that addresses the gap in functionality or convenience that currently exists between email and postal mail.

Therefore there is a need for a system and method that enables electronic communications between senders and recipients, but in a way that achieves a better balance between the diverging interests of consumers and business and government entities as such interests are described above.

### SUMMARY OF THE INVENTION

One aspect of the invention is a computer network implemented communication platform, enabled by a web based communication environment by operation of one or more server computers (“server”) that enables senders to send electronic communications to recipients based on location. In particular the communication platform of the present invention provides a unique, innovative solution for enabling senders and recipients to communicate, where the individuals and businesses who are the recipients are not known by the senders, only their location is known.

In another aspect of the invention, the system and method includes validation of the senders in the communication environment. In another aspect of the invention, the system and method includes validation of the recipients in the communication environment.

In yet another aspect of the invention, server includes or is linked to a map based tool or tools that enable a sender to select one or more recipients of the one or more communications based on location by selecting a location area using the map based tools and thereby selecting the location addresses linked to the system that are within the location area.

The communication system method and invention provides numerous advantages, including the ability to engage in location based communications and thereby providing the advantages of postal mail (in flexible location based communications, independent of the identity of the occupants or particular locations), while realizing the significant environmental and cost benefits of electronic communications generally.

In one aspect, the present disclosure relates to a computer network implemented communication platform, comprising: one or more server computers, the server computers incorporating one or more computer processors operable to configure and provide a server application, the server application being operable to provide: a web application operable: to validate one or more senders as associated with one or more locations; to validate one or more recipients as each associated with a particular location address; to create a location based inbox for each of the one or more recipients; for each of the one or more senders to assemble and send electronic communications to at least one of the one or more recipients via the location based inbox of each of said recipients based on the particular location address; to store the electronic communications in the location based inbox to be accessible and retrievable by the one of the one or more recipients associated with the location based inbox; one or more databases operable to store and make accessible information relating to the one or more senders and the one or more recipients; and a web environment connection operable to facilitate sending and receiving the electronic communications.

The platform of the present disclosure may further incorporate the web application being operable to apply online and offline processing to validate the one or more senders to the computer network implemented communication platform.

The platform of the present disclosure may further incorporate the web application being operable for the electronic communications to be sent to at least one of the one more recipients based on the particular location address and the name of at least one of the one or more recipients.

The platform of the disclosure may further incorporate the location based inbox being accessible via a mobile device.

The platform of the present disclosure may further incorporate the web environment connection being operable for the web application to integrate with one or more social media applications.

The platform of the present disclosure may further incorporate the web application being operable to provide a map based communication delivery utility to each of the one or more senders whereby one or more geographic areas are definable, each geographic area being associated with a plurality of particular locations, and identify all of the one or more recipients that are associated with the plurality of particular locations, and assemble and send electronic communications to said identified one or more recipients.

The platform of the present disclosure may further incorporate the web application that incorporates the following: an administration utility operable to: require that each of the one or more senders register with the server computer and in so doing engage in a workflow defined by an operator of the server computer for validation of the particular sender; and require that each of the one or more recipients register with the server computer and in so doing engage in a workflow defined by an operator of the server computer for validation of the particular recipient; a filter utility operable to verify that each of the one or more senders is validated before the electronic communications are sent by said sender and that said sender is authorized to send the electronic communication based on a profile of said sender including information relating to said sender; a web presentment utility operable to provide content as web objects for presenting a variety of web screens to provide access to the resources of the web application; a map send utility operable to send electronic communications based on location, by selecting at least one of the one or more recipients within a mapped location and utilizing one or more map based tools and associated interfaces to identify the mapped location; an analytics engine operable to analyze any of the following: registrations of the one or more recipients within specific locations; registrations of the one or more senders within specific locations; electronic communications sent and received based on specific locations; and information stored to the one or more databases; and a reporting utility operable to generate one or more reports or feeds based on output from the analytics engine relating to any of the following: recipient metrics; statistics based on data received from the communication utility; and information based on location.

The platform of the present disclosure may further incorporate a profile manager being operable to manage; the information relating to each of the one or more senders as sender profiles; and the information relating to each of the one or more recipients as recipient profiles.

In another aspect, the present disclosure relates to a method of implementing a computer network implemented communication platform, comprising the steps of: registering one or more senders with the platform as associated with a specific location by a web application incorporated in the platform operable by one or more computer processors of one or more server computers, and validating the one or more senders during registration; the one or more senders identifying a target geographic location and sending communications to particular locations within said target geographic location as online or offline communications; registering one or more recipients with the platform as associated with a location by the web application and validating the one or more recipients during registration; generating an inbox for each of the one or more recipients that are registered and validated; each of the one or more senders generating and sending one or more electronic communications to at least one of the one or more recipients selected for being associated with a selected geographic location; receiving the one or more electronic communications in the inbox of the at least one of the one or more recipients to whom said electronic communication was sent; accessing and retrieving the one or more electronic communications from the inbox; and notifying each of the one or more senders when the one or more electronic communications sent by said sender is accessed and retrieved from the inbox.

The method of the present disclosure may comprise the further step of applying one or more validation steps to the validation of each of the one or more recipients.

The method of the present disclosure may comprise the further step of applying the one or more validation steps to include one or more of the following: each of the one or more recipients confirming an active location address associated with said recipient to achieve a first level validation; and each of the one or more recipients providing information or documents to verify said recipient's identity and address to achieve a second level validation.

The method of the present disclosure may comprise the further step of providing one or more bills showing the name and address of said recipient and confirming the name and address shown on the one or more bills is identical to said recipient's profile information.

The method of the present disclosure may comprise the further step of identifying each of the one or more recipients as having achieved a first level validation or a second level validation.

The method of the present disclosure may comprise the further step of the one of the one or more senders sending a communication that is a letter sent by regular mail to an occupant of a particular location that provides a registration code and link for use by said occupant during registration as one of the one or more recipients.

The method of the present disclosure may comprise the further step of the one or more senders designing and implementing one or more campaigns and sending electronic communications to at least one of the one or more recipients as part of said one or more campaigns.

The method of the present disclosure may comprise the further step of assessing the results of the one or more campaigns.

The method of the present disclosure may comprise the further step of initiating a change of address process whereby the one or more recipients indicate a change of address to the platform.

The method of the present disclosure may comprise the further step of the one or more senders utilizing one or more map tools to select the target geographic location or the selected geographic location.

The method of the present disclosure may comprise the further step of one of the one or more senders sending electronic communications to at least one of the one or more recipients by providing the selected geographic location and a name of one or more of the one or more recipients.

The method of the present disclosure may comprise the further step of sending offline communications that are communications sent via the regular mail of the postal service.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 illustrates a schematic diagram depicting one embodiment of the system of the present invention.

FIG. 2 illustrates one aspect of the method of the present invention, more specifically registration by a user to the system.

FIG. 3 illustrates another aspect of the system of the present invention, namely the functions of the communication management utility of the present invention.

FIG. 4a illustrates a representative interface for receiving ECOMAIL, in one particular implementation of the invention, showing that when a user opens his/her inbox, received ECOMAILs are displayed with the sender's address.

FIG. 4b illustrates a representative interface for receiving ECOMAIL, in one particular implementation of the invention, in this case illustrating a user navigating through his/her ECOMAIL inbox.

FIG. 4c illustrates a representative interface for sending ECOMAIL, in this case using a map interface in accordance with one aspect of the invention.

FIG. 4d illustrates another step in sending ECOMAIL, in a particular aspect of implementation of the invention.

FIG. 5 illustrates a generic computer implementation of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The present invention is a computer network implemented communication system and method is provided that enables unknown entities (e.g., individuals, businesses or government organizations, referred to collectively as “entities”) to communicate with one another, even if there is no prior relationship established between said entities.

One embodiment of the present invention may incorporate a computer network implemented communication platform, enabled by a web environment by operation of one or more server computers (“server”) that enables senders to send electronic communications to recipients based on location. In particular the communication platform of the present invention may provide a unique, innovative solution for enabling senders and recipients to communicate, and the individuals and businesses who are the recipients to be unknown by the senders, and only their location is known. This form of communication provides numerous advantages over the prior art, including the ability to engage in location based communications and thereby providing the advantages of postal mail (in flexible location based communications, independent of the identity of the occupants or particular locations), while realizing the significant environmental and cost benefits of electronic communications generally.

The communication platform of the present invention depends on adoption by users so as to form a base of recipients, with whom senders may communicate based on location via the communication platform. Without critical mass in the user base, it is difficult to motivate senders, many of whom may use postal mail because of the advantages previously described, to adopt use of the communication platform of the present invention. The inventors have developed an innovative approach to attracting users to their platform.

A first aspect of the system and method of the present invention that enables adoption of the platform includes addressing some of the concerns of users regarding the receipt of unqualified communications. Many entities receiving postal mail receive mail from questionable entities for example illegitimate businesses such as pyramid schemes and the like. Postal mail is attractive to such entities because they are able to escape scrutiny from consumer protection agencies for example by omitting sender information from their postal communications. The inventors have found that the ability of questionable entities to send such communications by postal mail, which is unwanted by the recipients, and results in waste and environmental pollution, is a significant annoyance to a large segment of the population.

As explained below, while the communication platform provides a generally open platform, in which any registered sender may send communications to all recipients linked to the system, one or more validation criteria are nonetheless applied to the senders, which can be understood as minimum requirements, that may be operable to limit or discourage such questionable or illegitimate entities from sending communications via the platform, in part because of the requirement to provide certain minimum information to the operator of the web server, as explained below, for example an address for the individual, business, or government entity. This requirement in and of itself may discourage such questionable or illegitimate entities, and thereby their communications to recipients.

Therefore, in one embodiment of the present invention, the system is configured, and the method includes, one or more validation steps associated with senders associated with the platform of the invention, and the computer network communication environment enabled by the platform. In another embodiment of the present invention, one or more validation steps are associated with the recipients associated with the platform of the present invention, and the computer network communication environment associated with the platform of the present invention. Further details regarding these validation steps are explained below under the heading “Registration Method”.

It should be understood that an entity that uses the platform of the present invention, such as for example a university or a corporation, may use the platform to create one or more sub-entities or “communities” that may reflect sub-entities, such as, for example a department, a division, a group, a faculty, an office, or some other sub-entity. For example, the Biology department of a university may create a “community” on the platform of the present invention that is based in part on a collection of specific locations, for example a collection of offices on a particular floor or hallway, particular office wing, an entire floor, selected floors of a building, an entire building or two or more buildings defining a zone in a campus. Various alternatives are possible. It is important to note that physical locations with multiple buildings, multiple facilities within a building, and multiple sub-entities, as defined above, can pose challenges in enabling effective communication with a plurality of users, where it is desirable to define groups of users for communication purposes. The membership in these groups can change often. For example, change may occur because of turnover of personnel, regular physical moves (such that traditional mail may end up in the wrong location), and/or structural changes such that sub-entities merge or their name changes. In this kind of environment, which is common on university campuses but also for example corporate campuses or large office environments, there are numerous settings where communication based on location addresses a number of the mentioned issues.

It should be understood that the platform of the present invention enables groups of authorized users to create and modify groups of recipients, based on location. For example, to continue with the Biology department example, a sender may send a piece of electronic mail to the “BIOLOGY DEPARTMENT” sub-entity within the platform, which may relate to all recipients in the system associated with that location. The sender this way does not need to worry about researchers who may have moved on, or new ones that may have recently arrived and do not appear yet on traditional mailing lists (electronic or paper based). The sender can simply send the communication with improved assurance that the electronic mail sent by the platform of the present invention, will reach its intended destination. It should be understood that especially in the types of environments described, despite access to email, because of the difficulty in managing email lists because of frequent changes, as described, content that one wishes to ensure is received by the occupants of a particular location are often sent in paper form by office drop off, rather than sending same electronically. This contributes to cost in terms of the production of the materials, and also delivery. The present invention provides a more cost effective and environmentally friendly for addressing group communications in this kind of environment.

It should be understood that the platform of the present invention may include functionality for creating and managing other types of groups such as “clubs” of friends and the like. Because the location based platform of the present invention provides a useful mechanism for addressing certain types of communications, the platform of the present invention may be used by certain users as a general purpose communication tool, possibly for sending traditional electronic communications based on the identity of the user and also for example as a platform for social networking. It should be understood that it is contemplated that the platform of the present invention is extended to include or link to such other communication systems or social networks.

It should also be understood that user adoption may also be driven using one or more marketing campaigns that stress the environmental benefits of reducing paper postal mail by registering with the platform of the present invention, creating a list of possible recipients of mail by operation of the communication platform (branded “ECOMAIL”). A marketing campaign may initially take the form of a postal mailing advertising the benefits of the platform of the invention. Entities associated with a particular physical location such as a postal address may receive one or more incentives for registering with the platform of the present invention. The mailing may include may contain a web link for registering to the system. Particular geographic areas may be associated with special platforms, providing a particular link for that area, and associating registrations with particular promotions. For example, incentives such as coupons or the like, from local businesses or other companies interested in running promotions targeting certain areas. The mailing may be supported by other forms of media communications including advertising through newspapers, magazines, local internet bulletin, local papers, radio, television, internet television, and other forms of media communications.

It should be understood that the present invention may be deployed first through universities and colleges as these institutions may represent a microcosm of a national population, and based on diversity of the student population this commercialization path can aid in user adoption of the platform, in order to generate critical mass of adoption for the platform, which in turn motivates further adoption.

The initial mailing may also include invitations and/or incentives for recipients to invite their social media contacts to all participate in registration.

It should also be understood that certain locations may be associated with characteristics that enable them to derive especially significant advantages from use of the present invention. For example condo developments, where it may not be practical for a large segment of occupants to establish personal connections enabling for example exchange of traditional email addresses, or large rental properties that in addition are subject to significant turnover in occupancy, making communications for example from one or more occupants to one or more other occupants more difficult. The system and method of the present invention provides important convenience in enabling communications, for example, such as communications around numerous issues of collective interest to groups or communities. As an example, communication to residents, such as, keeping residents informed of security issues, construction issues, condominium board issues, etc.

In another embodiment of the present invention, universities, colleges or other entitles having campuses, generally include offices, labs, and other locations. Entities occupying specific locations may not know one another but there is an interest in communicating with one another. One of the challenges of entities occupying these locations is the significant turnover that exists, for example, such as in student residences. In one embodiment of the present invention, the operator of the system targets such campuses to drive adoption of the platform. In one embodiment of the administration utility of the present invention, users may be automatically registered to the system of the present invention, for example by engaging with an entity that controls address information for multiple entities, and has the right to use the information. For example, a university, in order to enable communication on campus, may automatically register its staff and students (subject for example to privacy related consents), using associated location information, in order to leverage the advantages of the system and method of the present invention. This can be accomplished using the automated registration utility of the administration utility, as described below.

It should be understood that the present invention is not limited to a particular application of the technology, however, the above examples are useful examples in explaining the advantages of the present invention.

### Marketing Communications

In one embodiment of the present invention, the system and the method of the present invention provides a novel computer network implemented communication platform and method for enabling communications between one or more entities (e.g., individuals, businesses, government entities, etc.) with one or more other recipients based on location for marketing purposes. The innovation of this marketing communication platform of the present invention is in part based on a unique and innovative balance between the interest of businesses and government entities to send communications to recipients, even if unsolicited, and the consumer interest in limiting communications, especially from senders who are not trusted. This is not to say that the sender must be known to the recipient in order to communicate with recipients by operation of the communication platform. Rather a relationship of trust or relative trust is established by the operator of the server and the various associated recipients, and the operator of the server plays a role in validating the various senders. The threshold of such validation is set as a “reasonable” level, which is further explained below, and significantly may be adjusted jurisdiction by jurisdiction based, for example, on local regulatory requirements or “spam” laws, but also in part based on local perceptions of what constitutes a trusted sender.

It should be understood that the present invention presents an open communication network, where senders may freely send communications to recipients. While it is contemplated that recipients may be able to elect to apply one or more filters that may act to block certain types of communications to their ECOMAIL account, the greater the blocking the less the incentive for senders to use the system, and greater the demand as a result to use postal mail, despite the environmental disadvantages in particular. It is therefore contemplated that the platform of the present invention may be configured with minimum or no filtering of content but minimum validation of the senders themselves, through registration to the system. The validation requirements, as further explained below, may be established dynamically, be altered depending on location, or nature of the business or operations of the sender entity, or a host of other criteria that may evolve over time. This flexibility in the system, in terms of the range of validation criteria, the application of criteria to selected groups of senders (for example based on geography) provides significant advantages in enabling a global location based electronic communication platform.

### System Implementation

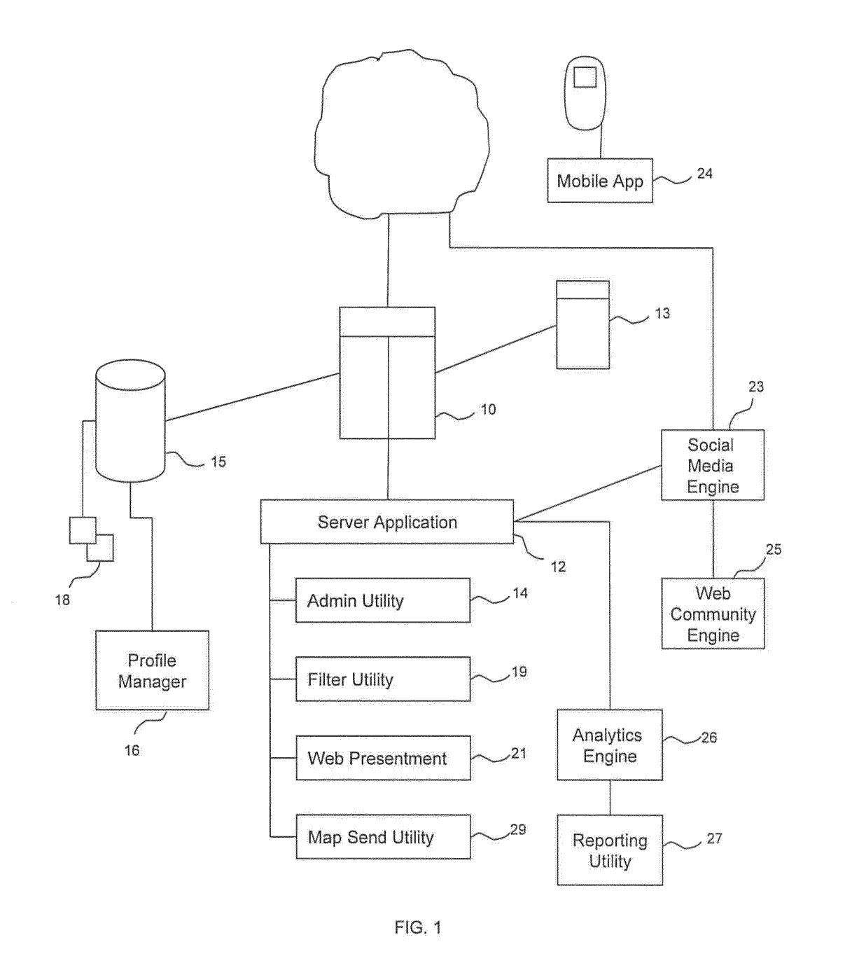

As best shown in FIG. 1, the server (10) is associated with a server application (12) that is operable to co-operate with the server (10) in order to configure the communication platform referred to in this disclosure.

The server (10) may include or be linked to a communication utility (13), which may be implemented as one or more communication servers, using known hardware, software, and middle ware, linked to one or more communication networks, for enabling messaging in one or more formats. In another aspect of the communication utility (13), it is best understood as providing a web based email program, which can be accessed by recipients registered to the system, for example by providing a user name and password, and thereby accessing an electronic mailbox linked to the system that enables the receipt of location based communications. The communication utility (13) may be configured for example to send notifications of receipt of location based communications for example by operation of mobile application (24) or by sending notifications to other email addresses associated with a recipient, or by text message to a mobile device associate with the recipient, and so on.

It is important to understand that the server (10) and/or other resources linked to, or part of the server (10) such as the communication utility (13) may be implemented using one or more server computers, or distributed architectures involving one or more computer, peer-to-peer implementation, cloud based implementations, or any manner of computer architecture.

The server application (12) includes an administration utility (14), which requires that each sender register with the server (10) and in so doing engage in a workflow defined by the operator of the server (10) for validation of the particular sender. This may require for example that the sender provide a business address in a specific location, an administrative contact name and contact information, and business registration information. The administration utility (14) may incorporate programming that performs one or more automated processes for validating the mentioned organization information associated with the sender. The organization information may be input to a database (15) linked to the server (10) by operation of a profile manager (16) which enables the operator and its staff to manage the profiles (18) for each sender, and optionally each recipient. In the case of a sender, the profile (18) may contain a number of fields including required information for sending communications via the communication platform, and also optionally linked to copies of documents such as validation reports related to organization information, or business registration details. The profile (18) for the sender will contain one or more setting defining the scope of the communication permissions, whether this is set manually by the operator in its back office, or whether this is defined dynamically based on the information provided, or other factors such as the location of the sender, or a trust score determined for example based on checks regarding the sender with for example Better Business Bureaus and the like that may report on business practices.

The contents of the profile (18) at the relevant time may determine the nature and scope of the communications authorized by operation of the communication platform.

The communication platform is configured to ensure that only senders validated at the time of the communication are authorized to send communication, based on their profile (18), by operation of a filter utility (19) that is implemented to the server application (12). In a further aspect of the invention, if there may be differences in validation requirements from one geographic area to another, for example from one legal jurisdiction to jurisdiction based on differing legal requirements. In this case, by operation of the filter utility (19), the ability of a sender to communicate with a group of recipients may be automatically filtered.

The platform of the present invention may further include a web presentment utility (21) that is best understood as a WMS that is operable to provide content as web objects for presenting the various web screens for providing access to the resources of server application (12).

It should be understood that the server application (12) may also include or be linked to other resources that enable operations that relate to or are complementary of the communication operations described. For example the server application (12) may include or be associated with a social media engine (23) and/or web community engine (25), for enabling engagement between users of the communication platform.

The social media engine (23) is best understood as a computer program or series of computer programs that provide the means for any manner of electronic communications between users of the system including but not limited to discussion threads, message boards, instant messaging, posts, blogs, etc. The social media utility contemplates the use of any existing and any to be deployed form of social media. The social media utility also enables the linking of the system of the invention to third party social media utilities, for example, such as FACEBOOK™ and others. In this way the social media utility acts as an interface between the system and third party systems so as to enable the extraction of meta data from the social interactions occurring in relation to the third party system to the extent that these are between users of the present system.

The social media engine (23) may constitute a third party social networking platform, for example, such as FACEBOOK™. The server application (12) may enable one or more users to define one or more groups based on location based email lists stored to the database (15), and the social media engine (23) may be used to enable one or more web based social networks based on such groups. Alternatively, the social media engine may be a social networking platform of the operator of the server application (12) based on one or more web utilities, for enabling social network interactions between groups of users. The social media engine (23) may be utilized to leverage the location based communications, and contacts established based on these communications, to enable social media interactions based on location.

It should be understood that the platform of the present invention may be further leveraged as a tool for confirming the validation of individuals in third party platforms. As explained above, the system of the present invention may be used to provide one or more levels of validation that an individual associated with a particular electronic identifier, for example, such as unique user name associated with the platform of the present invention, is who s/he says they are, or at least who s/he says they are within an acceptable degree of likelihood. Therefore, a third party application whether an e-commerce engine, or a social networking platform, may relate on the platform of the present invention to confirm aspects relating to a user, such as the identify of a user, based on the link to a location that is confirmable by the present invention, or that, for example, a particular user is associated with a particular location, based on verification by the platform of the present invention. This manageable level of validation could reduce the ability of social networking users to use false identities or impersonate others. Also, as expressed previously, the present invention contemplates differing levels of validation.

For example, if A meets B in Linkedin™, and A needs to confirm B's identity, A could ask B to send an email by operation of the platform of the present invention (for example the email of the present invention could be integrated with Linkedin™), thereby confirming B's location and thereby increasing the likelihood that B is who they claim to be. This can also be used to validate information provided by B.

Web community engine (25) may provide a series of tools that enable the creation of community bulletin boards or utilities that may be based on a particular location, such as a neighbourhood, campus building, or condominium building. The web community engine (25) may allow for example one or mores registered users to create and maintain web content (e.g., text, graphics, audio, video, etc.) that may be of interest in a particular location. The location based lists generated by operation of the system of the invention may enable for example the advertisement of updates to the local bulletin board, thus further enabling community.

It should be understood that the location based community based interactions enabled by the social media engine (23) and/or the web community engine (25) act as a further incentive for registering with the system, and for expanding the footprint of the platform within particular locations.

Optionally, the platform of the present invention can include or be linked to an analytics engine (26) that is operable to analyze for example, for the operator of the system, user registrations within specific locations, communications sent and received based on specific locations, and other analysis data based on the data stored to the database (15). The analysis data may assist the operator in selectively promoting adoption of the system by users in specific locations, and/or revealing revenue opportunities for the operator of the system.

The analytics engine (26) may also analyze the data in the database (15) to obtain metrics for the benefit of sender entities, for enabling them to manage and configure marketing campaigns, in a manner that is known.

The analytics engine (26) may be linked to a reporting utility (27) that is operable to generate, based on output from the analytics engine (26), a variety of reports or feeds, relating, for example, to recipient metrics, such as statistics for opening of specific emails or attachments received from the communication utility, based on location, etc. These reports may be consumed, for example, by content providers, customers of the operator of the platform, or sponsors of content. The feeds may be used, for example, automatically in connection with the operation of an ad server in regards to placement of advertisements in the various web pages that may be associated with the system of the present invention.

In other words, the communication platform is configured to enable dynamic filtration of senders based on one or more minimum validation criteria which may evolve with time, based on location, or other factors based on criteria established by the operator of the platform, and not controlled by the registered recipients to the system.

### Registration Method

As explained above, the system and method enables one or more validation steps, these being related to validating senders as being authorized to use the system, and also being related to validating the recipients as being authorized to receive communication by operation of the system. The validation steps, in one embodiment of the present invention, are integrated with one or more operations for registering with the server application (12), for example by operation of its administrative utility (14).

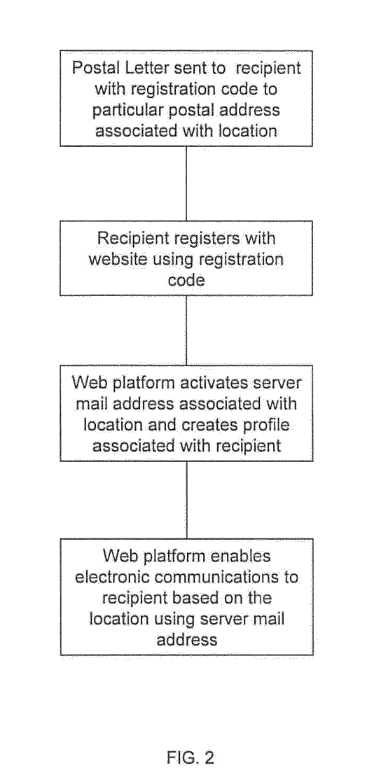

An example of related operations or workflow of the method of the invention, implemented by the system of the present invention, may be understood by referring to FIG. 2.

As explained above, the minimal validation of senders in the system of the invention builds on the comfort of the recipients in using the system and method of the present invention, and in building trust, in part because of the ability of the system to filter certain senders if they are not validated.

The validation of recipients, for example as explained in greater detail below, also provides advantages, especially to senders. This attracts senders to the system, and motivates sender to promote the system and method to their users and potential users.

Validation of Senders

Therefore in one aspect of the present invention, the system is configured, and the method includes, one or more validations steps associated with senders associated with the platform of the invention, and the computer network communication environment enabled by the platform. In another aspect of the invention, one or more validations steps are associated with the recipients associated with the platform of the invention, and the computer network communication environment associated with the platform of the invention. Further details regarding these validation steps are explained below under the heading “Registration Method”.

Validation of Recipients

Recipients may also be registered to the system of the present invention. In one aspect of the invention, the list of recipients connected to the server (10) is based on physical addresses such as postal addresses rather than a combination for example of name and address. This serves a number of purposes. First, many communications that senders wish to dispatch are targeted based on location, for example, all residents in neighbourhood A, or all students at residence B. An additional challenge in sending communications that are location based is that individuals may move, and especially for example on university or college campuses (residences and teaching/research facilities), these moves may be frequent. Keeping mailings lists up to date can be a significant challenge, and can be costly. Furthermore, invariably mailings are sent to the wrong destination, requiring additional resources for these to be redirected, or as is often the case the mailing arriving at the wrong destination is simply thrown out, which is a waste of resource.

As best illustrated in FIG. 2, recipients may be registered to the system of the present invention, by sending for example a traditional postal letter to the occupant of a particular location, providing a registration code and link for example, and asking that the individual residing at that location register to the system using this information. Alternatively, mailing lists may be leveraged to create profiles automatically in the database (15). The profile manager (16) is operable to compile records of locations, and associated individual information, as this may become available from time to time.

Recipients can be added by senders. When a sender decides to send a communication to a particular geographic area, in one implementation of the invention, the system is operable to indicate (for example using a map interface) a plurality of locations within the geographic area (for example the specific street addresses in a particular geographic area) and also (in the same view or in an alternate view) the specific locations that are associated with active accounts associated with the platform and the specific locations that are not associated with active accounts associated with the platform. In one embodiment of the present invention, a mechanism is provided whereby a first user may initiate an “invite” to specific locations (and thereby the one or more second users associated with those specific locations) within the geographic area to participate in the platform of the present invention. It is important to understand that the first user need not know anything about the second users. An example of the implementation of the present invention is a first user who wants to communicate with his/her neighbours in his/her immediate vicinity whom he may not know by name. The “invite” function of the present invention triggers the sending of a postal letter to the second users/recipients who are not yet registered with the platform of the present invention. This postal letter may indicate the address associated with the first user, and again may not disclose the name or other information associated with the individual, however, based on location alone (i.e. the fact that the first user lives in the vicinity of the second user) this may motivate the second users to register with the system of the present invention. This aspect is important in building location based networks, as enabled by the present invention, and also is an important aspect in promoting adopting of the system, which in turn improves the value of the platform as a communication tool.

Upon registration, each second user may receive a message indicating that a message is waiting for the second user in his/her inbox. If s/he opens the account, this enables the second users to establish their rights over the account associated with their particular location. It should be understood that various incentives may be associated with registration to the system, or the referral of registrants to the system. In another aspect of the invention, the first users themselves may be invited to print off and deliver to the correct location the postal letter. Or they may be required to post and assume the cost of posting the invitation letter described, but in exchange for incentives available through the system. These and other similar mechanisms may be used to mobilize users to motivate other users to register to the platform of the invention.

In one aspect of the invention, the administrative utility (14) may include or implement one or more resources that enable the creation of electronic mail boxes (with an associated location based unique address in the system, known as an ECOMAIL address, and the electronic mail boxes may be known as ECOMAIL boxes), and the skeleton of an associated profile for each physical address (which may be a postal address but may also include multiple locations with a single postal address, for example LAB A in a campus building having a particular postal address) within a defined area. In other words, the system may be “pre-populated” with ECOMAIL boxes and associated ECOMAIL addresses. Once an ECOMAIL box and ECOMAIL address is created, the system may be operable to initiate the delivery by postal mail of a letter containing registration information to the occupant of the location.

When registering with the system, the occupant of the location, via the administration utility (14), the occupant of the location may be invited to provide and may store to the database (15) other information, which may be included in his/her profile (18) such as full name, and other particulars that may be required or desired. This act of registration confirms the participation of the occupant of the location in the system as a recipient (and potentially also as a sender) and activates the particular location as an “active location address” for use by the system, including email lists assembled by operation of the server application (12), and linking of the associated profile with the map send utility (29) referenced below. This aspect of registration in one implementation of the invention may be seen as a “first level validation” of the location address associated with the system.

The invention contemplates a second optional or second level validation of the location address, which is operable to further validate the identity of the occupants, associated the location address. Such second level validation continues to enable senders, using the platform of the present invention, to send communications based on location, but also enables validation that the registered recipient associated with a particular location has received a particular communication.

The second level validation may involve a variety of different steps including for example provision of information or documents, and these steps may vary, for example, there may be validation based on jurisdiction, or other factors. For second level validation, a recipient may be asked to provide one or more bills that link the name of the recipient with his/her address. The bills may for example be scanned and email to the server (10), and the server application (12) may be operable to extract the relevant information, verify same, and store such verification in the applicable profile (18). Alternatively, the sender may be asked for certain information such as a driver license number or other information, and the server application (12) may be linked to a database or online directory that enables one or more lookup operations in order to verify such information, and based on such verification completed a second level validation for the recipient, and store such verification in the applicable profile (18).

The server application (12) may be further operable to log (possibly to the profile (18)) when a particular recipient has accessed his/her ECOMAIL box on the system, and also which emails and/or associated documents s/he has accessed or viewed by operation of the system.

The combination of the second level validation and logging may be sufficient to demonstrate that the recipient has received a particular communication or linked document, sent through ECOMAIL. This can provide significant advantages to senders, for example to entitles interested benefiting from a deemed acceptance rule or being able to counter a claim by the recipient that s/he did not receive a particular communication on a particular day.

Communications sent by operation of the communication platform of the present invention. In one aspect thereof, are sent to a plurality of destinations stored to the database (15), which are associated with the selected recipient profiles. These recipient profiles also include the name and other information associated with a particular destination, i.e. physical address. But sometimes, the associated individual may have moved, resulting in the need to update the name and other information.

Change of Address

In another aspect of the invention, related to the registration method and part of the operations enabled by the administrative utility (14) the system and method includes a change of address component or operation. In one embodiment of the present invention, the web presentment utility (21) is operable to present to recipients one or more screens that enable them to indicate that they are changing their address.

When user A moves from location A to a new location B, he/she will enter the new address to the system. The system will validate new address B if it is a new account. In other words, the system will initiate the sending of a validating postal mail, as described above. When sender C sends an electronic communication by operation of the platform to user A at location A, but A moved to location B, the system will recognize the name of the recipient A and redirect it to the new location B. This occurs when sender C types name of user A when sending electronic communications by operation of the platform of the present invention or ECOMAIL. Because the system knows that user A moved to location B, the system in one implementation can only redirect ECOMAIL if sender C types the name of recipient A. If sender C sends ECOMAIL to an anonymous recipient, or in other words, sender C sends ECOMAIL to whoever occupies location A, then the ECOMAIL will reach to the new occupant of location A. Of course, in this case, there is no redirecting since the system assumes that sender C is not messaging user A in particular, but rather only the resident or occupant of location A whoever that individual may be. In other words, in a particular implementation of the technology of the present invention, the “Change of Address” feature is only activated when the sender types the name of the recipient, together with his/her address.

It should be understood that more than one individual may be associated with a single location, for example roommates or office mates for example. In this case the system may be operable to create and maintain more than one ECOMAIL box for a single address. Multiple accounts for a same location will be differentiated by name of user, or, in cases of privacy, with a different letter. For instance, when John Smith sends an ECOMAIL, the sender will be either “John Smith 630 Fort Washington ave 6J” or, “630 Fort Washington ave 6J, A” according to John Smith's privacy preferences. With this, the change of address process may account for the fact that a change of address initiated by one individual may not invalidate one or more other ECOMAIL boxes for that location.

If sender D sends ECOMAIL to the previous occupant of location B, where A now resides, and sender D types the name of that previous occupant B, then the system will redirect the ECOMAIL to the new location of recipient B only if recipient B following for example the steps to activate the “Change of Address” feature as described above. If recipient B did not activate the feature, the ECOMAIL will be returned to sender D, replicating the way postal mail is returned when sent to invalid addresses or recipients. But ECOMAIL of sender D will not reach the inbox of user A, now residing in location B. The process described may be followed where sender D types the name of recipient D. When D does not type the name of the recipient, that is D is sending an ECOMAIL to anyone residing location B, then new occupant A will receive that ECOMAIL, as explained above.

### Communication Management Utility

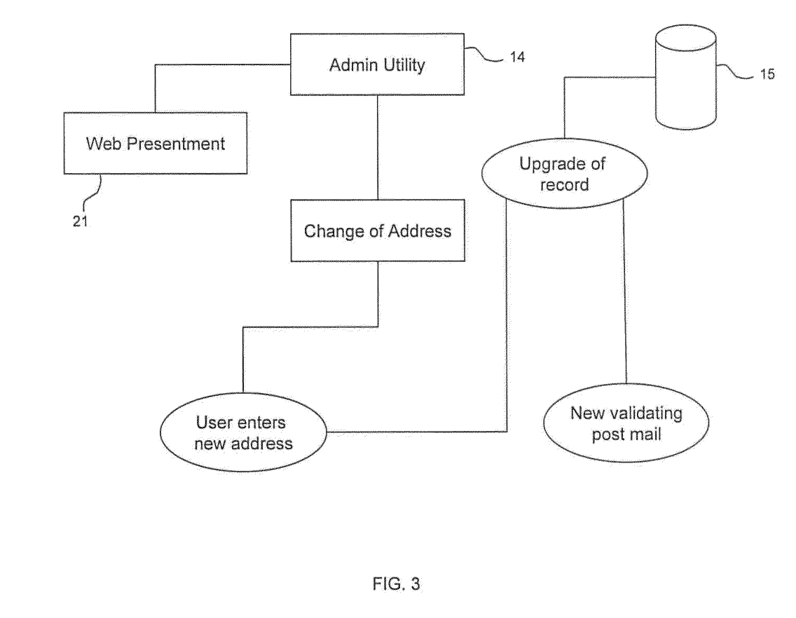

As best illustrated in FIG. 3, the sender registered to the system, initiates the communication of a message by operation of the communication management utility (20) that is part of the server application (12). This is best understood as a web mail application, configured to enable the sender to compose messages, incorporate artwork into messages, and attach files of various types. It is contemplated that the communication management utility (20) may include any and all features of various electronic communication tools, including specialized e-marketing platforms for example. The communication management utility (20) may be implemented in a manner that is known, by providing one or more tools that are similar to known campaign manager platforms used, for example, by advertisers to design and implement campaigns or other initiatives, such as email campaigns.

The communication platform of the present invention, however, enables the novel and innovative processes by which communications composed in this way are sent to a plurality of recipients linked to the system based on selected collections of physical addresses for example an area on a map, or zip code or some other location identifier, and the various physical addresses within this area that are registered to the system.

Significantly, the communication management utility (20) includes one or more tools enabling the selection of collections of physical addresses, such as for example interfaces including map data that enable the sender to select specific areas, using a number of tools, technologies, or processes that are known.

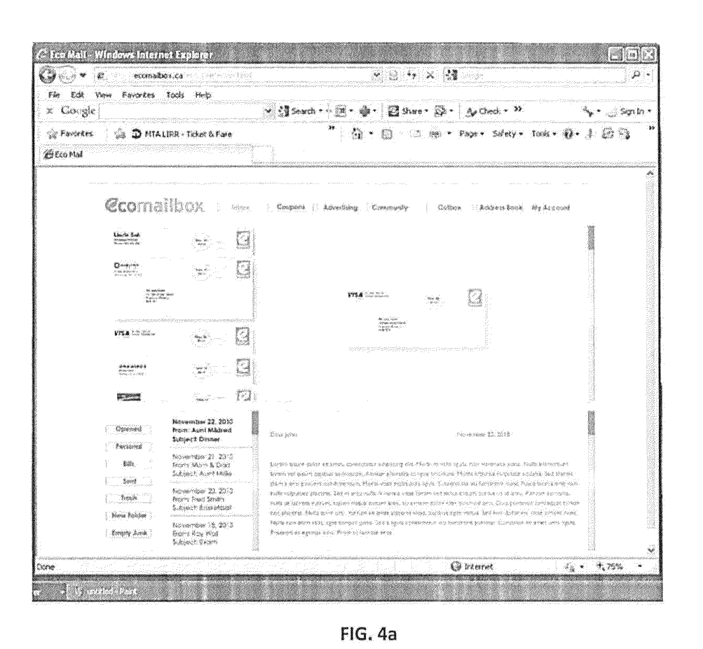

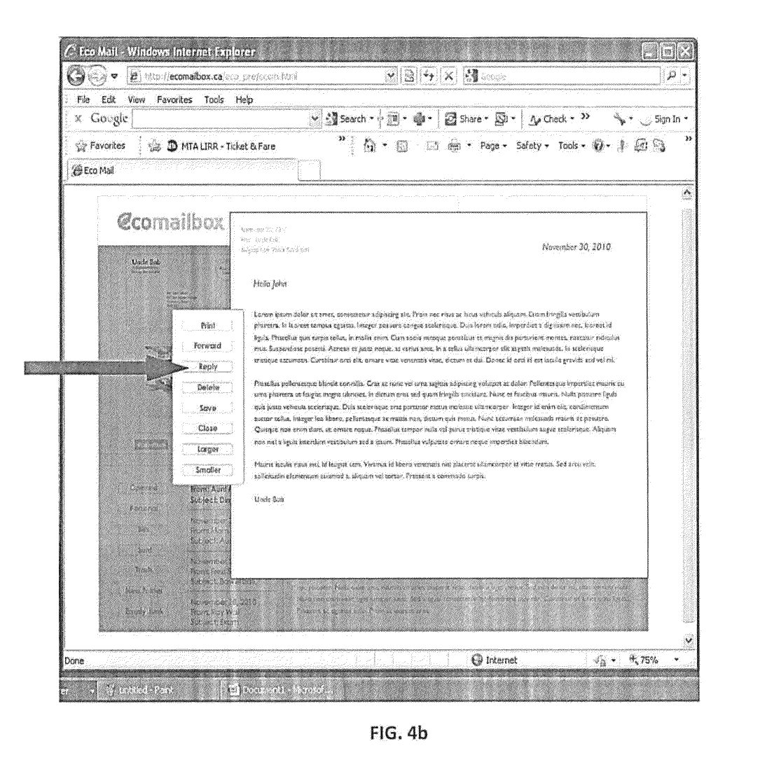

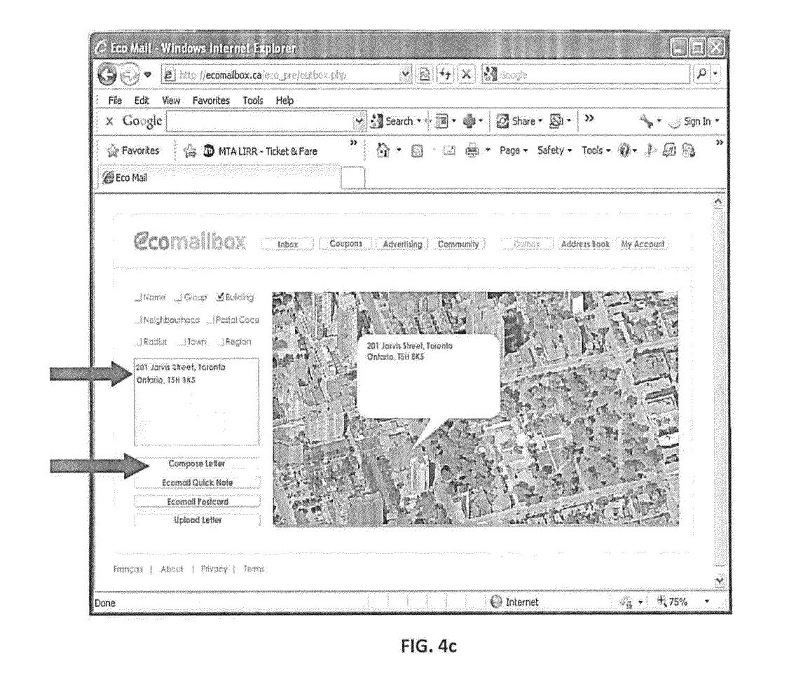

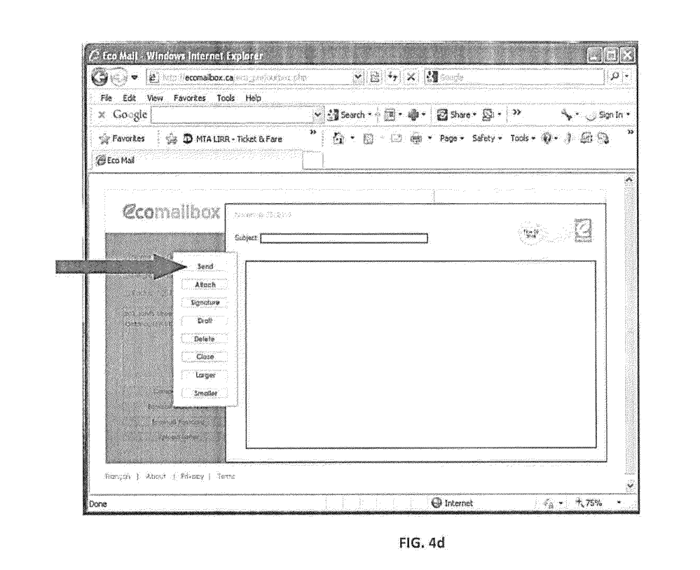

A representative recipient selection interface is included in FIGS. 4a,b,c,d. One or more interfaces presented by the communication management utility (20) enable the sender to see selected recipient information that assists in customizing the messaging initiated via the communication platform. For example, the communication management utility displays sender information for a defined area, such as number of registered users within a defined area, demographic information for such recipients (subject to privacy requirements) and so on.

In particular FIG. 4a illustrates a representative web interface presented by the communication management utility (20), which illustrates that when a user accesses the web application, his/her ECOMAIL inbox is brought up, containing all electronic communication sent to the location associated with him/her. The mail may initial be accessed by clicking for example on a list, and retrieving of view of an envelope indicating the ECOMAIL, as addressed, as well as the sender. An additional view described below provides a preview of the contents.

FIG. 4b illustrates that a user may click on any particular ECOMAIL to bring up a larger view of the contents of the letter, and in this embodiment when a user clicks on the contents, a menu including possible actions pops up, including for example, “PRINT”, “FORWARD”, “REPLY”, etc.

Also, the communication management utility (20) may include or be linked to a map send utility (29) that enables one or more senders to send communications based on location, by operation of the system, by selecting recipients using one or more map based tools and associated interfaces, as best shown in FIG. 4c.

The map send utility (29) shown in FIG. 3c may be implemented in a number of ways; using known map based functionality and possibly even based on third party map data and associated address information. In one embodiment of this aspect of the system of the present invention, each profile (18) is associated with physical address information, and this physical address information is linked to one or more maps, or the physical address information is linked to address information that is associated with the one or more maps. This can be achieved using for example one or more known database utilities. Accordingly, a number of map based features for sending location based communications can be enabled in the system.

Other mechanisms for sending ECOMAIL are possible, including, for example, using a directory of locations by entering strings of address information, then the system being operable to match this information to a location directory.

Once a location is selected or multiple locations, a “SEND” screen is displayed as shown in FIG. 3d.

For example, one or more maps may be marked (through an overlay or marking functions built into the map objects) so that where locations are associated with ECOMAIL boxes in the system, those locations are marked by a coloured pin graphic. Different colours may be used to indicated different characteristics associated with the ECOMAIL boxes. For example, one colour may be used if the location address is associated with first level validation, and another colour may be used if the location address is associated with second level validation.

One or more buttons may be associated with the interface, enabling a sender to select, for example, “NEIGHBOURHOOD” mode, where if a sender clicks on a particular area of a map, then all location addresses within the defined neighbourhood is selected. Another button may enable selection of “ZIP CODE” mode, which enables by clicking in a particular location of a map, selection of all location addresses within an applicable zip code. When such an area is selected in a map, the selected area may change colour. By clicking on a particular pin, profile information for that location may be displayed.

A selection tool may enable, for example, a user to click on multiple points and define an area on the map. Then, using a mouse, the user may be able to pull the boundaries of the areas in different directions, in a manner similar to the tools used to operate computer assisted drawing applications.

A number of other tools are possible, for example, such as text based parsers for selecting zip codes or selected streets.

The present invention contemplates the use of a wide variety of tools, including existing tools and tools to be developed, to select the particular location addresses to which one or more communications will be sent by operation of the invention.

It should be understood that the communication management utility (20) may be operable to provide information regarding the delivery of communications to senders. This may include the generation of lists of recipients, and an indication as to which of the recipients were subject to first level validation, and which of the recipients were subject to second level validation. The lists may be organized based on location and location/name information if this is associated with the applicable profiles (18). The lists indicating second level validation may be useful to a sender because these recipients may be deemed to have accepted certain communications (as explained above), whereas the recipients who are subject to first level validation may be able to contest receipt of the location based communication. This may prompt the sender to follow up with certain recipients and encourage them to complete second level validation, whether using one or more incentives or otherwise.

In one embodiment of the present invention, the communication management utility (20) may be implemented by providing an advertising system that enables one or more entities (for example advertisers, who may be acting on behalf of their clients) to create and manage one or more advertising programs, levering the communication and system method described herein.

Advertisers or other entities sending ECOMAIL to selected groups may create/activate one or more lists of recipients, for example by selecting one or more locations from a map that indicate that the location is associated with a recipient that has previously picked up or replied to, or otherwise interacted with, ECOMAIL. By doing this, senders can gauge the interest in interacting with the platform of the present invention, based on locations. For example, a coffee outlet chain may decide to send a marketing message by ECOMAIL, promoting to residents of different neighbourhoods a new product or service offering associated with their local store. The coffee outlet chain may track sales following such a campaign, and compare this information to activities tracked by operation of the platform of the present invention. The results of the tracking may provide insight regarding the purchasing behaviour and/or effectiveness of the marketing campaign that would not have been otherwise available.

For example, the coffee outlet chain may develop insights regarding which areas to target for specific products, for example because residents in a particular location are more interested in the product, or because residents in that location are more receptive to ECOMAIL advertising. As a consequence, the chain may decide to discontinue ECOMAILing in certain areas with low feedback, and/or may decide to target more aggressively areas where the feedback has been more positive. The chain may also decide to engage in further direct marketing activities such as use of postal direct mail to announce a new product or service in areas where ECOMAIL based marketing shows the best results to further increase market traction. It is noted that this is meant to illustrate only one of the possible ways in which the novel and innovative location based communication functionality provided by the present invention may be used for marketing purposes. Various other uses will be obvious to a skilled reader.

In a particular embodiment of the present invention, the platform of the present invention may present to a marketer a series of different tools. Said tools may be so presented using one or more user interfaces that enable users (for example marketing client users of the present platform) to access and manage a variety of possible functions enabled by the present invention. For example, the system of the present invention may be operable to register feedback of a collective ECOMAIL on the map by indicating with a different colour or shape those locations where the occupant has previously replied to or otherwise interacted with ECOMAIL, for example based on a receipt confirmation registered by the system upon the user reading an ECOMAIL.

For example, John Smith, as a candidate for mayor of Toronto, may send an advertisement ECOMAIL to all the ECOMAIL accounts in Toronto with his proposed policies. He may activate the “receipt confirmation” feature. Each recipient opening Smith's ECOMAIL will be asked to confirm reading/receiving the ECOMAIL. Those interested recipients will confirm reading/receiving the ECOMAIL. In some cases, some recipient constituents will suggest other policies, or express opinions regarding Mr. Smith's candidacy by answering the ECOMAIL. Now, the system will generate a map for John Smith in which locations where recipients who have confirmed reading an ECOMAIL from Mr. Smith, or the particular ECOMAIL from Mr. Smith, will be displayed by the platform of the present invention in a different colour/shape, or recipients who answered will appear with a different colour/shape. The platform is operable to log receipt confirmations and dynamically generate maps displaying this information in a manner that is known.

As a further example, candidate John Smith can also ask in the ECOMAIL questions like: “Would you vote for John Smith?” The system will generate a map for John Smith in which recipients who answered YES will appear in a particular colour, such as red, and recipients who answered NO will appear in a particular colour, such as blue. Mr. Smith and his team may derive various insights from this information, for example, such as: the locations where Mr. Smith should be canvassing door to door more; the locations where he should be attending more events; and other intelligence. This particular example illustrates the manner in which the platform may enable location based communications that can then be used to derive or mine location based information that provides meaningful location based or location influenced information that was not previously available, and also that this information can be generated or derived in an efficient manner. It should be understood that analytics engine (26) may be used, for example, to analyze data associated with in formation relating to ECOMAIL, such as the reply to ECOMAIL, and the content of the reply to ECOMAIL, or other information, subject to privacy laws, so as to derive meaningful analytics data, informed in part by location by operation of the platform of the present invention.

### Statement of Advantages

The system of the present invention, in other words, represents a unique and innovative set of features and processes that bridges the gap between postal mail and email communications, and that provides significant environmental and community advantages. The system and method also saves significant resources for numerous senders, especially entities that for the reasons stated above need in certain circumstances to engage in mass postal mailings.

Other advantages include:

1. Improved safety:
1.1. Compared to postal mail, the platform of the present invention enables the confirmation of both the sender and recipient. The validation process confirms sender addresses by, for example, confirming that the sender is associated with the physical address. In embodiments of the present invention, additional information associated with individuals linked to physical addresses may be required, such as confirmation of their name. These mechanisms may be used to confer legal status with validated ECOMAIL accounts in a way that postal mail does not provide.
1.2. Compared to email: The system is safer/more efficient than email systems because it is closed, and there is control over incoming/outgoing messages.
   2. The platform of the present invention also enables targeting of recipients based on location with no requirement of previous knowledge or consent. This functionality does not exist in any other virtual system. While traditional postal mail enables communication to be delivered with no previous knowledge or consent, this is not associated with a mechanism to verify that the communication has been actively received, as opposed to being left unopened, shredded, or thrown in the recycling. This is a significant limitation to traditional postal mail in the sense that it is difficult to verify the meaningful receipt (without discarding) as opposed to assumed receipt (with high percentage of discarding as studies have shown). By linking a web enabled platform to location as provided in this disclosure verification that a particular communication has been opened is possible, without the requirement of previous knowledge or consent which is normally associated with email communication. Senders place a premium on communications where it is possible to measure and validate meaningful receipt. The platform addresses this requirement in an innovative way. In addition, the platform of the present invention includes a series of tools that provide innovative interaction with the platform functions such as for example map based recipient selection tools as explained above rather than management of mailing lists for traditional postal mail which is time consuming and makes selected or targeted communications difficult, usually resulting in overreaching desired scope of communication which adds to the cost and environmental waste associated with mass mailings. Furthermore, there are time limitations to postal mailings which electronic communications using the present platform addresses. For example University X may have numerous buildings scattered throughout a city. Although it knows which department(s) occupies building Y, many times departments move around, or one department occupies many buildings, or the information of their locations is not readily accessible to the sender. University X administrator, however, may desire to send a message to all employees working at building Y about a break in the electrical system of building Y. University X can transfer that message easily, rapidly with just selecting Building Y from the map. This is not possible with the postal system.
   3. More efficient than emails: there is a charge for ECOMAIL delivery which senders will pay for, but this acts as an automatic filter whereby senders will avoid sending indiscriminate emails and because of the costs will exercise greater care in determining whether particular recipients (based on local interests for example) will be interested in a particular promotion or offering. This in turn increases the degree of interest for average ECOMAIL recipients in communication sent using the platform, which provides a benefit to senders. Recipients receive the benefit of reduced spam or at least more relevant communications.
   4. Universal access: recipients may access their inbox from any computer. Postal letters require presence to be read. Recipients are busy and on the move. Once home, they are interested in spending personal time rather than managing a paper based in box. Bills and other important communications are piling up more and more due to this phenomenon. Recipients would prefer to sift through these communications at preferred down times such as during their commute, in the elevator or on their lunch break, and have the convenience of automatically flagging information, forwarding information, or acting on the information using for electronic payment platforms, or platforms that aggregate multiple communications such as online accounting platforms. Postal letters require physical presence to be read and therefore are increasingly less convenient.
   5. Environmental advantages: savings in paper, transportation, ink, etc.
   6. Automatic Change of Address: at no cost, for unlimited time, ECOMAILs are redirected to new addresses. Postal services charge of this service, offer limited time, and limit the type of mail to be redirected.
   7. Reduced price of messaging: ECOMAILs cost a fraction (5% approximate) of the cost of a postal letter. Main beneficiaries of this advantage are direct marketing companies or any entity with a great number of clients/recipients. Advertisers can increase their reach, or begin new campaigns.
   8. Marketing tools based on the present platform, or integrated with the present platform, enable better targeting/filtering of advertising based on location by operation of the platform.

### Further Details of Possible Implementation

One embodiment of the present invention may be implemented as a computer program. Server application software and databases may execute on both centralized computers and distributed, decentralized systems. The internet or any other private or public network (for example a company's intranet) may be used as the network to communicate between the centralized servers and the various computing devices and distributed systems that interact with it.

In one aspect of the computer program, the user interface may be provided to a user via a web server that is operable to deliver web pages. In particular the computer program includes a web presentment utility that is operable to generate a series of web pages that incorporate content generated by operation of the present invention.

The present invention may also be operable over a wireless infrastructure. Present wireless devices are often provided with web browsing capabilities, whether through WAP or traditional means. The user interface of the present invention may be provided to the wireless devices, with processing occurring on the server side of the communication channel or any server associated with such a network.

It should be understood that via the social media engine (23), which may be a third party social media engine linked to the platform of the present invention, video debate content created via the platform may be shared for example using FACEBOOK™, likely with the consent of one or more of the participants' consent.

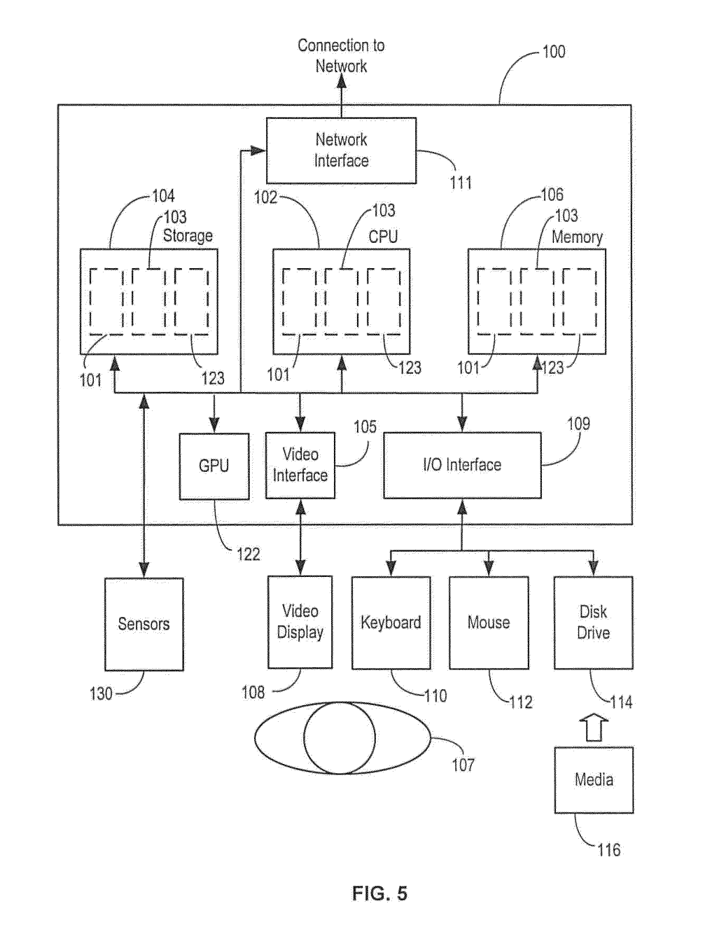

The present system and method may be practiced in various embodiments. A suitably configured computer device, and associated communications networks, devices, software and firmware may provide a platform for enabling one or more embodiments as described above. By way of example, FIG. 5 shows a generic computer device (100) that may include a central processing unit (“CPU”) (102) connected to a storage unit (104) and to a random access memory (106). The CPU (102) may process an operating system (101), application program (103), and data (123). The operating system (101), application program (103), and data (123) may be stored in storage unit (104) and loaded into memory (106), as may be required. Computer device (100) may further include a graphics processing unit (GPU) (122) which is operatively connected to CPU (102) and to memory (106) to offload intensive image processing calculations from CPU (102) and run these calculations in parallel with CPU (102). An operator (107) may interact with the computer device (100) using a video display (108) connected by a video interface (105), and various input/output devices such as a keyboard (110), mouse (112), and disk drive or solid state drive (114) connected by an I/O interface (109). In known manner, the mouse (112) may be configured to control movement of a cursor in the video display (108), and to operate various graphical user interface (GUI) controls appearing in the video display (108) with a mouse button. The disk drive or solid state drive (114) may be configured to accept computer readable media (116). The computer device (100) may form part of a network via a network interface (111), allowing the computer device (100) to communicate with other suitably configured data processing systems (not shown). One or more different types of sensors (130) may be used to receive input from various sources.

The present system and method may be practiced on virtually any manner of computer device including a desktop computer, laptop computer, tablet computer or wireless handheld.

It should also be understood that the server application (12) may be configured to communicate with one or more wireless devices, enabling location based communications to recipients, where communications are optimized by operation of the server application (12) or a resource linked to the server application (12) for particular wireless devices. As shown in FIG. 1, the server (10) may be linked to a wireless gateway for enabling wireless communications between the server (10) and multiple recipients registered to the system. In addition, the computer program of the present invention may include one or more software components that provide a mobile application (24) that may be installed on a mobile device, enabling a sender to use the mobile application (24) to manage communications sent based on location by operation of the present invention. The mobile application (24) may also enable a user of the mobile device to access one or more resources of the server application (12) from a mobile device. The web presentment utility (21) may be operable to extract information from for example the reporting.

The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

We claim:

1. A computer network implemented communication platform, comprising:
(a) one or more server computers, the server computers incorporating one or more computer processors operable to configure and provide a server application, the server application being operable to provide:
(i) a web application operable: to validate one or more senders as associated with one or more locations; to validate one or more recipients as each associated with a particular location address; to create a location based inbox for each of the one or more recipients; for each of the one or more senders to assemble and send electronic communications to at least one of the one or more recipients via the location based inbox of each of said recipients based on the particular location address; to store the electronic communications in the location based inbox to be accessible and retrievable by the one of the one or more recipients associated with the location based inbox;
(b) one or more databases operable to store and make accessible information relating to the one or more senders and the one or more recipients; and
(c) a web environment connection operable to facilitate sending and receiving the electronic communications.

2. The platform of claim 1, wherein the web application is operable to apply online and offline processing to validate the one or more senders to the computer network implemented communication platform.

3. The platform of claim 1, wherein the web application is operable for the electronic communications to be sent to at least one of the one more recipients based on the particular location address and the name of at least one of the one or more recipients.

4. The platform of claim 1, wherein the location based inbox is accessible via a mobile device.

5. The platform of claim 1, wherein the web environment connection is operable for the web application to integrate with one or more social media applications.

6. The platform of claim 1, wherein the web application is operable to provide a map based communication delivery utility to each of the one or more senders whereby one or more geographic areas are definable, each geographic area being associated with a plurality of particular locations, and identify all of the one or more recipients that are associated with the plurality of particular locations, and assemble and send electronic communications to said identified one or more recipients.

7. The platform of claim 1, wherein the web application incorporates the following:
(a) an administration utility operable to: require that each of the one or more senders register with the server computer and in so doing engage in a workflow defined by an operator of the server computer for validation of the particular sender; and require that each of the one or more recipients register with the server computer and in so doing engage in a workflow defined by an operator of the server computer for validation of the particular recipient;
(b) a filter utility operable to verify that each of the one or more senders is validated before the electronic communications are sent by said sender and that said sender is authorized to send the electronic communication based on a profile of said sender including information relating to said sender;
(c) a web presentment utility operable to provide content as web objects for presenting a variety of web screens to provide access to the resources of the web application;
(d) a map send utility operable to send electronic communications based on location, by selecting at least one of the one or more recipients within a mapped location and utilizing one or more map based tools and associated interfaces to identify the mapped location;
(e) an analytics engine operable to analyze any of the following: registrations of the one or more recipients within specific locations; registrations of the one or more senders within specific locations; electronic communications sent and received based on specific locations; and information stored to the one or more databases; and
(f) a reporting utility operable to generate one or more reports or feeds based on output from the analytics engine relating to any of the following; recipient metrics; statistics based on data received from the communication utility; and information based on location.

8. The platform of claim 1, wherein a profile manager is operable to manage: the information relating to each of the one or more senders as sender profiles; and the information relating to each of the one or more recipients as recipient profiles.

9. A method of implementing a computer network implemented communication platform, comprising the steps of:
(a) registering one or more senders with the platform as associated with a specific location by a web application incorporated in the platform operable by one or more computer processors of one or more server computers, and validating the one or more senders during registration;
(b) the one or more senders identifying a target geographic location and sending communications to particular locations within said target geographic location as online or offline communications;
(c) registering one or more recipients with the platform as associated with a location by the web application and validating the one or more recipients during registration;
(d) generating an inbox for each of the one or more recipients that are registered and validated;
(e) each of the one or more senders generating and sending one or more electronic communications to at least one of the one or more recipients selected for being associated with a selected geographic location;
(f) receiving the one or more electronic communications in the inbox of the at least one of the one or more recipients to whom said electronic communication was sent;
(g) accessing and retrieving the one or more electronic communications from the inbox;
(h) notifying each of the one or more senders when the one or more electronic communications sent by said sender is accessed and retrieved from the inbox.

10. The method of claim 9, comprising the further step of applying one or more validation steps to the validation of each of the one or more recipients.

11. The method of claim 10, comprising the further step of applying the one or more validation steps to include one or more of the following:
(a) each of the one or more recipients confirming an active location address associated with said recipient to achieve a first level validation; and
(b) each of the one or more recipients providing information or documents to verify said recipient's identity and address to achieve a second level validation.

12. The method of claim 11, comprising the further step of providing one or more bills showing the name and address of said recipient and confirming the name and address shown on the one or more bills is identical to said recipient's profile information.

13. The method of claim 10, comprising the further step of identifying each of the one or more recipients as having achieved a first level validation or a second level validation.

14. The method of claim 9, comprising the further step of the one of the one or more senders sending a communication that is a letter sent by regular mail to an occupant of a particular location that provides a registration code and link for use by said occupant during registration as one of the one or more recipients.

15. The method of claim 9, comprising the further step of the one or more senders designing and implementing one or more campaigns and sending electronic communications to at least one of the one or more recipients as part of said one or more campaigns.

16. The method of claim 9, comprising the further step of assessing the results of the one or more campaigns.

17. The method of claim 9, comprising the further step of initiating a change of address process whereby the one or more recipients indicate a change of address to the platform.

18. The method of claim 9, comprising the further step of the one or more senders utilizing one or more map tools to select the target geographic location or the selected geographic location.

19. The method of claim 9, comprising the further step of one of the one or more senders sending electronic communications to at least one of the one or more recipients by providing the selected geographic location and a name of one or more of the one or more recipients.

20. The method of claim 9, comprising the further step of sending offline communications that are communications sent via the regular mail of the postal service.
